(19) United States
(12) Patent Application Publication
(10) Pub. No.: US 2006/0146836 A1
(43) Pub. Date: Jul. 6, 2006

(54) Centralized call control

(76) Inventors: Kyung Rok Park, San Jose, CA (US); Santhosh K. Vasanthakumar, San Jose, CA (US)

Correspondence Address: HARNESS, DICKEY & PIERCE, P.L.C., P.O. BOX 8910, RESTON, VA, 20195, US

(21) Appl. No.: 11/024,456

(22) Filed: Dec. 30, 2004

(51) Int. Cl. H04L 12/56

(52) U.S. Cl. 370/399

(57) ABSTRACT

Centralized call control includes establishing a communication channel in a multiple leg architecture by instructing each leg, in the architecture, forming a desired path within the architecture to use a same key for a communication channel.

### BACKGROUND OF THE INVENTION

1. Field of the Invention

The present invention relates to a multiple subscriber port architecture such as for DSL (digital subscriber line) and methods of operation.

2. Description of Related Art

FIG. 1 illustrates a prior art multiple port call handling unit 10 for DSL (digital subscriber line). As shown, the unit 10 includes a control module (CM) 12 having one or more network ports 14. The CM 12 includes one or more switches 13 (often referred to as switch fabric) and a controller (not shown) controlling the switches to establish connections with a number of slots 16. The slots may hold different types of modules such as a line-interface-module (LIM) 18 as shown in FIG. 1. A LIM 18 also includes one or more switches 19 and a controller (not shown) controlling the switches (again, often referred to as switch fabric) to establish connects with a number of subscriber ports 20.

For example, the network port 14 may be connected to a Gigabit Ethernet or optical network providing a trunk to, for example, the internet. The subscriber ports 20 may be connected via physical links to subscriber DSL mode(ms, which connect the subscriber to the unit 10. The unit 10 then provides internet connections for the subscribers by establishing communication channels between the subscriber ports 20 and the network port 14.

An operator of the unit 10 interfaces with the CM 12 through a provisioning port 22. Via this interface, the operator configures the unit 10 such that the CM 12 may set up the necessary internal connections between the CM 12 and the LIMs 18 as wells as within the LIMs 18 to the subscriber ports 20 to create the paths between the network ports 14 to the subscriber ports 20.

Often the unit 10 is referred to as a shelf in reference to the actual physical appearance of the unit 10. The number of subscriber ports 20 of a shelf 10 is limited by the number of subscriber ports 20 supported by a LIM 18 and the number of LIMs 18 supported by the shelf 10.

### SUMMARY OF THE INVENTION

To provide a greater number of subscriber ports, multiple shelves have been connected in a cascaded or tree architecture with the network port of one or more shelves being connected to the subscriber port of another shelf. However, this architecture requires provisioning each shelf in the system and re-provisioning the shelves or a number of the shelves each time a shelf is added or removed and each time a change is made to a shelf (e.g., adding or removing a LIM). Furthermore, the communication between the shelves to manage the architecture greatly increases the overall message overhead of the system and significantly impact bandwidth available for call handling.

The present invention provides for an architecture and method where control is centralized.

For example, in one embodiment, centralizing call control includes establishing a communication channel in a multiple leg architecture (e.g., a multiple subscriber port architecture) by instructing each leg in the architecture forming a desired path within the architecture to use a same key for a communication channel.

The architecture in one embodiment may include a first shelf and at least one second shelf. The first shelf may includes a controller having at least one network port and may include at least one module providing a number of subscriber ports. The controller may control operation of the first shelf. The second shelf has at least one interface connected to one of the subscriber ports or network port of the first shelf. The second shelf also may include a number of subscriber ports. The controller of the first shelf may control operation of the second shelf. For example, the controller of the first shelf may instruct each leg in the architecture forming a desired path within the architecture to use a same key for a communication channel.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a prior art multiple port call handling unit 10 for DSL (digital subscriber line);

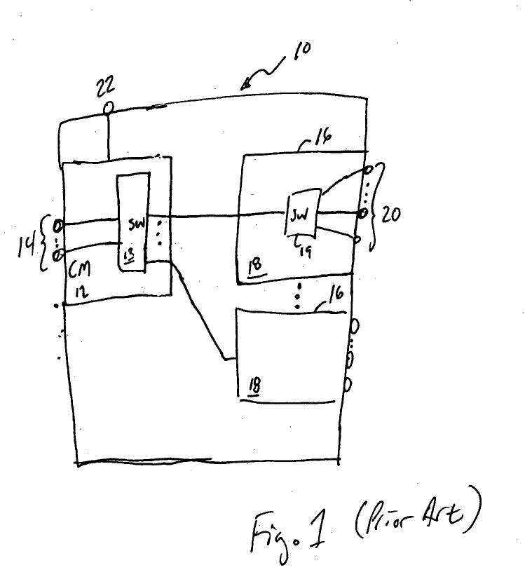

FIGS. 2A and 2B illustrate multiple subscriber port architectures according to embodiments of the present invention;

FIG. 3 illustrates an example format of the discovery packet according to the present invention;

FIG. 4 illustrates a portion of the architecture shown in FIG. 2 to show the control channels used by each leg of the architecture between the master shelf and a newly added shelf;

FIG. 5 illustrates a communication flow diagram between a secondary shelf and the primary shelf to initialize the secondary shelf according to an embodiment of the present invention;

FIG. 6 illustrates a communication flow diagram showing the messaging to establish the VPI/VCI within the architecture between a network port and a subscriber port being provisioned; and

FIG. 7 illustrates a portion of the architecture shown in FIG. 2 to show the provisioned channel used by each leg of the architecture after the communication flow of FIG. 6 takes place.

### DETAILED DESCRIPTION OF EMBODIMENTS

The present invention provides a multiple subscriber port architecture. For ease of description, embodiments of the invention for digital subscriber line (DSL) will be described in detail below. Specifically, embodiments of the architectures for DSL will be presented. Then, operation of an architecture according to embodiments of the present invention will be described.

### FIRST EXAMPLE ARCHITECTURE

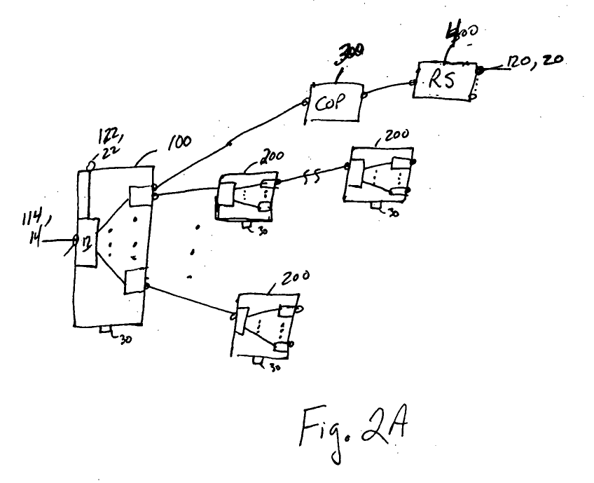

FIG. 2A illustrates a multiple subscriber port architecture according to an embodiment of the present invention. As shown, the architecture includes a primary shelf 100 and a number of secondary shelves 200 directly or indirectly connected to the primary shelf 100. The primary and secondary shelves 100 and 200 have the same structure as the shelf 10 discussed above with respect to the prior art except that (1) the primary and second shelves 100 and 200 have a selector 30 and (2) different software resident thereon for implementing the methods of the present invention. In one embodiment, the selector 30 may be manually operable to achieve at least one of two positions. In the first position, the selector 30 indicates to the shelf that the shelf is the master or primary shelf, and in the second position, the selector 30 indicates to the shelf that the shelf is a secondary or slave shelf.

As shown, the network port 14 of the CM 12 in the master shelf 100 provides the network port 140 for the architecture. Each slave shelf 200 is connected by its network port 14 to one of the subscriber ports 20 of the master shelf 200 or the subscriber port 20 of another slave shelf 200. The subscriber ports 20 of the terminal slave shelves 200 provide the subscriber ports 120 of the architecture. As shown, this architecture is scalable to provide an expanding number of subscriber ports 120 for a single network port 140.

FIG. 2A further shows that alternatively or in addition to slave or secondary shelves 200, a remote shelf 400 may be connected to a subscriber port 20 of the master shelf 100 via a hardline connection 300. For example, the hardline connection 300 may be a control and optics pack (COP). The COP 300 includes an optical fiber connection from a subscriber port 20 of the master shelf 100 to a controller (not shown) of the COP 300. The controller of the COP 300 function in the same manner as the CM 12 in the secondary shelves 200. The controller of the COP 300 is connected to the remote shelf 400 by an optical fiber. The remote shelf 400 is typically a single LIM having three subscriber ports; however, it will be appreciated that the present invention is not limited to this type of remote shelf 400. As will be appreciated, together the COP 300 and remote shelf 400 function in the same manner as a secondary shelf 200; albeit, the COP 300 and remote shelf 400 are not necessary co-located.

### SECOND EXAMPLE ARCHITECTURE

FIG. 2B illustrates another architecture according to an embodiment of the present invention. This architecture differs from the architecture of FIG. 2B in that the slave shelves 200 or remote shelves (not shown) are connected by their network port 14 to the network port 14 of another slave shelf 200 or the primary shelf 100.

As will be appreciated, the present invention is not limited to any one architecture. Nor is the present invention limited to the type of shelves or modules (e.g., LIM) in a shelf that have been described. Instead, it will be appreciated from the disclosure that the present invention is applicable to numerous modules, components, architectures, etc.

Operation

Next the operation of the architecture of FIG. 2A according to exemplary embodiments of the present invention will be described. It will be understood that these operations may be applied to the architecture of FIG. 2B as well as the numerous other architectures, etc. that fall within the present invention.

In the architecture of FIG. 2A, the CM 12 of the master shelf 100 provides centralized control of the architecture. Namely, functions previously performed by the CMs 12 resident at the slave shelves 200 are now performed at the CM 12 of the master shelf 100. By providing for centralized control in this manner, an operator may view the architecture as a single system in much the same way that the operator viewed a single shelf as a single system. More specifically, and as described in greater detail below, the architecture includes a single operator interface 122, which is the operator interface 22 of the master shelf 100. Through the operator interface 122, the operator may provision the entire architecture.

Furthermore, as described in detail below, the operator may be relieved of the burden of provisioning internal aspects (e.g., internal connections between master and slave shelves or between slave shelves) of the architecture. Accordingly, in describing the operation of the architecture, first methods for providing the system topology to the CM 12 of the master shelf 100 will be described. Then, methods for configuring each of the slave and remote shelves 200 and 400 will be described.

Topology

Next, methods for providing the topology of the architecture to the CM 12 of the primary shelf 100 will be described.

Auto-Discovery

According to one embodiment of the present invention, an auto-discovery method exists for providing the topology of the architecture to the CM 12 of the primary shelf 100. This method will be described with respect to a newly connected secondary shelf 200 in the architecture of FIG. 2A, but it will be appreciated from the previous and following disclosure that this method is equally applicable to a newly connected remote shelf 400 or to other architectures.

When a secondary shelf 200 is newly connected to the architecture and powered up, the CM 12 of the newly connected second shelf 200 sends a discovery packet over a discovery channel. Remember, based on the selector 30, a secondary shelf 200 know if it is a master or slave shelf. For the purposes of explanation, communication channels in the architecture are defined using the well-known virtual path identifier (VPI)/virtual channel identifier (VCI) technique in which a VPI/VCI pair define a unique communication channel. For the purposes of auto-discovery, a VPI/VCI is reserved for discovery communication purposes and pre-programmed into the switch fabric of each shelf.

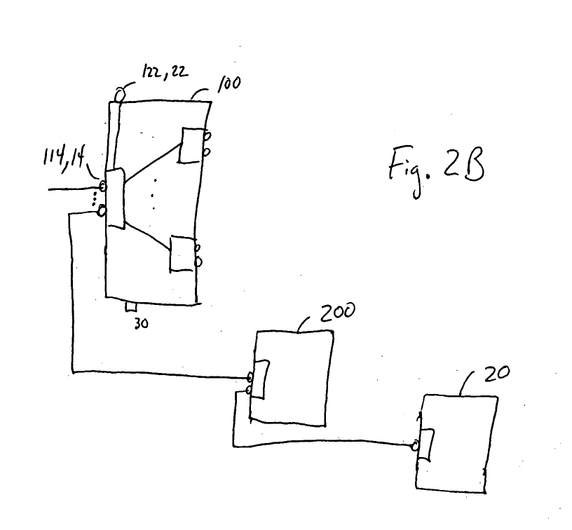

FIG. 3 illustrates an example format of the discovery packet. As shown, the discovery packet includes a protocol identifier identifying the protocol specifying the format of the discovery packet, a packet type identifier identifying the type of packet as a discovery packet and a length indicator indicating the length of the packet. Next, the discovery packet includes one or more topology identification sections.

When the newly connected secondary shelf 200 sends the discovery packet, the CM 12 thereof enters the protocol identifier, the packet type, the length and a topology identification section. As will be appreciated the protocol identifier entered by the CM 12 will depend upon version of the software resident on the CM 12. As shown in FIG. 3, the topology identification section includes a shelf identifier and a port identifier. Each shelf (primary and secondary) has a unique identifier assigned by the manufacturer. This shelf identifier is entered as the first part of the topology identification section. Also, as discussed above, the CM 12 may have one or more network ports 14, each with its own unique identifier. This port identifier is entered as the second part of the topology identification section.

Each secondary shelf 200 disposed between the newly connected secondary shelf and the master shelf 100 will receive the discover packet, and identify from the packet type that the packet is a discovery packet. Based on this identification, the intermediate secondary shelves 200 will each add, in sequence, a topology identification section to the discovery packet and update the length indicator of the discovery packet. The added topology identification section indicates the shelf identifier of the intermediate secondary shelf 200 and the port identifier of the network port 14 over which the intermediate secondary shelf 200 outputs the discovery packet.

When the master shelf 100 receives the discovery packet, the master shelf 100 identifies the packet as a discovery packet based on the packet type identifier, and knows the structure of the discovery packet based on the protocol identifier. Using this information and the length identifier, the CM 12 of the master shelf 100 obtains the topology identification section for each secondary shelf 200 in the path from the newly added secondary shelf 200 (the first topology identification section) to the master shelf 100. The CM 12 of the master shelf 100 then creates a database entry in a topology database kept at the CM 12. Each entry in the topology database provides a map of the architecture from the master shelf 100 to a secondary shelf 200 (or remote shelf 400). Specifically, this map will include the topology identification sections received in the discovery packet as well as an indication of, for example, the LIM 18 of the master shelf 100 over which the discovery packet was received.

If the primary or master shelf 100 properly receives the discovery packet, the master shelf 100 performs a table lookup for an available VPI/VCI to use as a control channel for the newly added secondary shelf 200. The CM 12 of the master shelf 100 maintains tables of available VPI/VCI pairs on a slot-by-slot basis. More specifically, the CM 12 of the master shelf 100 includes, for each slot 16 (and therefore each module in a slot 16) a table for control channels that has a pre-established range of possible VPI/VCI, and a table for data communication channels that has a pre-established range of possible VPI/VCI. By organizing the VPI/VCI on a slot-by-slot basis, the same VPI/VCI pairs may be used for each slot 16.

Using the available control channel table for the slot 16 over which the discovery packet was received, the CM 12 of the master shelf 100 chooses the next available VPI/VCI and assigns the chosen VPI/VCI as the control channel for the newly added secondary shelf 200. This VPI/VCI is also stored in the topology database in association with the newly added secondary shelf entry. The CM 12 of the master shelf 200 then sends an acknowledgement (ACK) packet to the newly added secondary shelf 200. The acknowledgment packet is sent over the same VPI/VCI over which the discovery packet was received, and the acknowledgement packet includes the assigned VPI/VCI control channel.

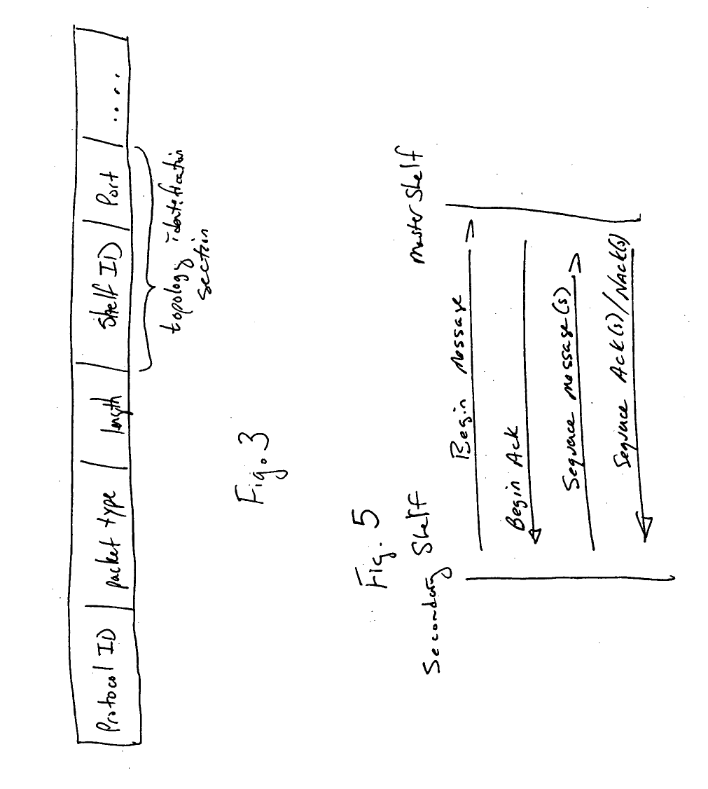

FIG. 4 illustrates a portion of the architecture shown in FIG. 2. In FIG. 4, the master shelf 100, the newly added secondary shelf 200 and a single intermediate secondary shelf 200 are shown in detail. Further, FIG. 4 shows the VPI/VCI used along each leg (e.g., switch fabric such as in each CM 12 and each LIM 18) of the path from the CM 12 of the master shelf 100 to the CM 12 of the newly added secondary shelf 200.

Generally, asynchronous transfer mode (ATM) networks establish VPI/VCI pairs along each leg such that each leg tends to have a different VPI/VCI pair. As will be appreciated, this requires mapping the packets received on a VPI/VCI from one leg into the VPI/VCI of the next leg. In the architecture of the present invention, this overhead is eliminated. Instead, as shown in FIG. 4, each leg (CM, LIM, etc.) adopts the VPI/VCI assigned by the CM 12 of the master shelf 100 for the communication channel between the master shelf 100 and the newly added secondary shelf 200.

As is known in the art of ATM networks, each leg stores a table or routing map that indicates the connection the switch fabric should make for each VPI/VCI pair stored in the table. Packets sent over the network include, as part of their data structure, an indication of the VPI/VCI over which they are being sent. In the above-described embodiment, certain connections, such as for the discovery packet VPI/VCI, are programmed into the routing maps for the switch fabric of each leg. In this manner, the MC 12 and the LIMs 18 of the secondary shelves 200 properly routes the discovery packet to the master shelf 100 from the newly added secondary shelf 200. When the acknowledgement packet is received over the same VPI/VCI, the legs in the secondary shelves 200 have already stored, as a result of the discovery packet, the connections to make. Furthermore, the secondary shelves 200 may further be preprogrammed to examine the acknowledgement packet to obtain the assigned VPI/VCI for the control channel, and create the proper entry in routing maps of each leg therein.

Other connections are set or programmed by, for example, the MC 12 of the master shelf 100 such as will described in detail below.

Manual Topology

Instead of adopting or in addition to adopting the auto-discovery topology method described above, an operator may manually establish the topology. In this embodiment, an operator, via interface 122, provides the CM 12 of the master shelf 100 with the topology information by entering the necessary information directly into the topology database. In addition, the operator may manually set the VPI/VCI control channel for a newly added secondary shelf 200.

Initialization

Next a method of initializing a newly added secondary shelf 200 will be described. However, it will be appreciated that this methodology may equally apply to a newly added COP 300 and remote shelf 400 pair.

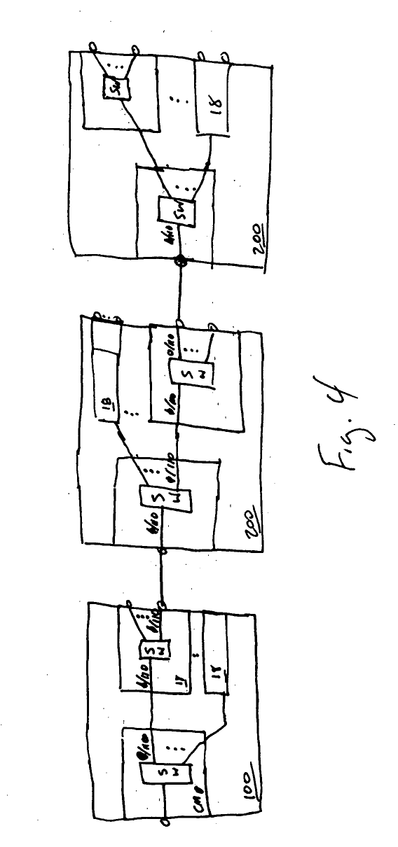

FIG. 5 illustrates a communication flow diagram of the messaging performed to initialize a newly added secondary shelf 400. In FIG. 5, any intermediate secondary shelves 200 that may exist have not been shown for the purposes of clarity. Furthermore, it will be understood that communication between the master shelf 100 (more particularly the CM 12 of the master shelf 100) and the secondary shelf 200 take place over the VPI/VCI control channel established according to one of the topology methods described above.

As shown in FIG. 5, after the VPI/VCI control channel is established, the CM 12 of the newly added secondary shelf 200 sends the master shelf 100 a Begin message over the VPI/VCI control channel. If properly received, the master shelf 100 returns a Begin acknowledgement message (ACK). If the Begin message is not properly received, the master shelf 100 returns a non-acknowledgement message (NACK). In general, when a NACK is received, the secondary shelf 200 re-sends the message being NACKed.

Assuming the master shelf 100 ACKs the Begin message, the newly added secondary shelf 200 then sends sequence data to the master shelf 100. The sequence data includes information on or identification of the numerous protocols according to which the secondary shelf 200 has been programmed to operate as well as information on the structure of the secondary shelf. For example, operational or functional protocols include, but are not limited to, a loader protocol, a sync clock protocol, a redundancy protocol, etc. The loader protocol indicates the protocol used by the secondary shelf 200 to load programming; for example, such as to load an updated version of the operational program for the CM 12 of the secondary shelf 200. The sync clock protocol indicates the protocol by which the internal synchronization clock maintains synchronization with the system. The redundancy protocol indicates the protocol by which switching to a different CM takes place if the current CM 12 fails.

As will be appreciated, the sequence information may be sent to the master shelf 100 over several packets or fragments. The data structure of these packets or fragments is a matter of design choice, but any well known packetization structure for sending a message may be used.

The information on the structure of the secondary shelf 200 includes, but is not limited to, the number of slots, the unique identifier of each slot, the module in each slot, the protocols by which each module operates, the structure of each module (e.g., if the module is a LIM the structure of each module information may indicate how many subcriber ports the LIM includes). Based on this structure information, the CM 12 of the master shelf 100 adds any further information to the to topology database.

In response to properly receiving the packets of the sequence information, the master shelf 100 sends ACKs. For those packets not properly received, the master shelf 100 sends NACKs.

During this initialization process, the secondary shelf 200 may continue to poll the master shelf 100 by sending poll messages on a periodic basis. In response to these poll messages, the master shelf 100 sends ACKs, the receipt of which at the secondary shelf 200 tells the secondary shelf 200 that the connection to the master shelf 100 still exists.

Once the master shelf 100 receives the sequence information, the master shelf 100 will know how to properly communicate with the secondary shelf 200. Knowing this, the master shelf 100 may reprogram the secondary shelf 200 (e.g., to update a version or software module, or change a protocol of operation). This process will be referred to as loading a new image or software operational load on the slave shelf 200. Namely, using the proper protocols, the CM 12 of the master shelf 100 instructs the secondary shelf 200 to reprogram based on the programs supplied to the secondary shelf 200 by the master shelf 100. The slave shelf 200 then reconfigures based on this new operational load. This reconfiguration may affect the processing performed by the CM 12 of the slave shelf 200 as well as operation of the modules in the slots of the slave shelf 200. In this manner, the secondary shelf 200 becomes the slave of the master shelve 100.

Furthermore, for purposes of directly affecting the switch fabric in, for example, each LIM 18 of a secondary shelf 200, the new operational load for the secondary shelf 200 informs the CM 12 of the secondary shelf 200 that the control channel for each LIM 18 is the control channel assigned to the CM 12 plus the number of the LIM 18 in the sequence of LIMs 18 for the secondary shelf 200. For example, if the CM 12 is assigned a control channel with a VPI/VCI of 0/50, then the first LIM 18 has a control channel with a VPI/VCI of 0/51, the second LIM 18 has a control channel with a VPI/VCI of 0/52, etc.

### Centralized Call Processing

Channel Management

As described above, the CM 12 of the master shelf 100 stores tables of available VPI/VCI pairs on a slot-by-slot basis for the slots 16 at the master shelf 100. More specifically, the CM 12 of the master shelf 100 has been described above as including, for each slot 16 (and therefore each module in a slot 16) a table for control channels that has a pre-established range of possible VPI/VCI. In addition, the master shelf 100 includes, for each slot 16, a table of available VPI/VCI pairs (more generally called keys) for packet data or circuit switched connections, operations and management (OAM), and test channels. Each table has a pre-established range of possible VPI/VCI that may overlap with the possible VPI/VCI of other tables. By organizing the VPI/VCI on a slot-by-slot basis, the same VPI/VCI pairs or keys may be used for each slot 16.

As will be appreciated, as for when a new control channel is established, the CM 12 of the master shelf 100 selects the next available VPI/VCI or key from the appropriate table for the appropriate slot 16 and deletes the selected VPI/VCI pair from the table to establish a packet data channel, OAM channel, etc. If that channel is later torn down, then the CM 12 of the master shelf 100 will add the VPI/VCI pair back to the appropriate table for the appropriate slot 16.

Provisioning

Next, provisioning of the architecture will be described according to one embodiment of the present invention. For the purposes of explanation, provisioning from the network port 140 to a subscriber port 120 for the portion of the architecture illustrated in FIG. 4 will be described. FIG. 4 illustrates a secondary shelf 200 connected to the master shelf 100 via one intermediate secondary shelf 200. While provisioning will be described with respect to this portion of the architecture, it will be understood that this embodiment of the present invention is not limited to this portion of the architecture or to the example architecture. For example, this provisioning embodiment is also applicable to provisioning a COP 300 and remote shelf 400, a secondary shelf 200 directly connected to the master shelf 100, a secondary shelf 200 connected to the master shelf 100 via any number of intermediate secondary shelves 200, and/or other architectures (e.g., FIG. 2B) or portions thereof.

Furthermore, provisioning of a packet data channel will be described. This packet data channel may provide, for example, internet access via the network port 140 to a DSL subscriber connected to one of the subscriber ports 120 of the terminal secondary shelf 200 shown in FIG. 4. To provision this data channel, a system operator interfaces with the architecture via the operator interface 122. The operator supplies the CM 12 of the master shelf 100 with a connection profile for the subscriber. The connection profile indicates the subscriber end point information and system end point information for the connection. The subscriber end point information indicates the unique identifier of the subscriber port 120 and the VPI/VCI assigned to the connection between the subscriber port 120 and the subscriber. The system end point information indicates, in this example, the unique identifier of the network interface port 140 and the VPI/VCI assigned to the connection between the network interface port 140. The connection profile may also include other connection related information such as encapsulation information, bridging/routing information, and other ATM/IP related parameters.

The CM 12 of the master shelf 100 stores this information in a profile database using a connection profile name created according to a naming convention that allows the CM 12 to readily construct the connection profile name and subsequently access the connection profile to perform various functions as described herein.

Next, the CM 12 of the master shelf 100 access the topology database based on the identified subscriber port 120 and determines the topology of the architecture from the CM 12 of the master shelf 100 to the subscriber port 120 of the secondary shelf 200 being provisioned. More specifically, from the topology database, the CM 12 of the master shelf 100 knows the LIM 18 of the master shelf 100 connected to the subscriber port 120 being provisioned, the structure of any intermediate secondary shelves 200, and the structure of the secondary shelf 200 including the subscriber port 120 being provisioned.

From the set of tables of available VPI/VCI pairs for the LIM 18 of the master shelf 100 connected to the subscriber port 120 being provisioned, the CM 12 of the master shelf 100 selects the appropriate table. In this example, the table for packet data connections is selected. From this table, the CM 12 of the master shelf 100 selects the next available VPI/VCI pair. The CM 12 of the master shelf 100 then informs each leg (LIM and CM) providing the connection between the network port 140 and the subscriber port 120 being provisioned to use the selected VPI/VCI. As will be appreciated, the selected VPI/VCI is removed from the table.

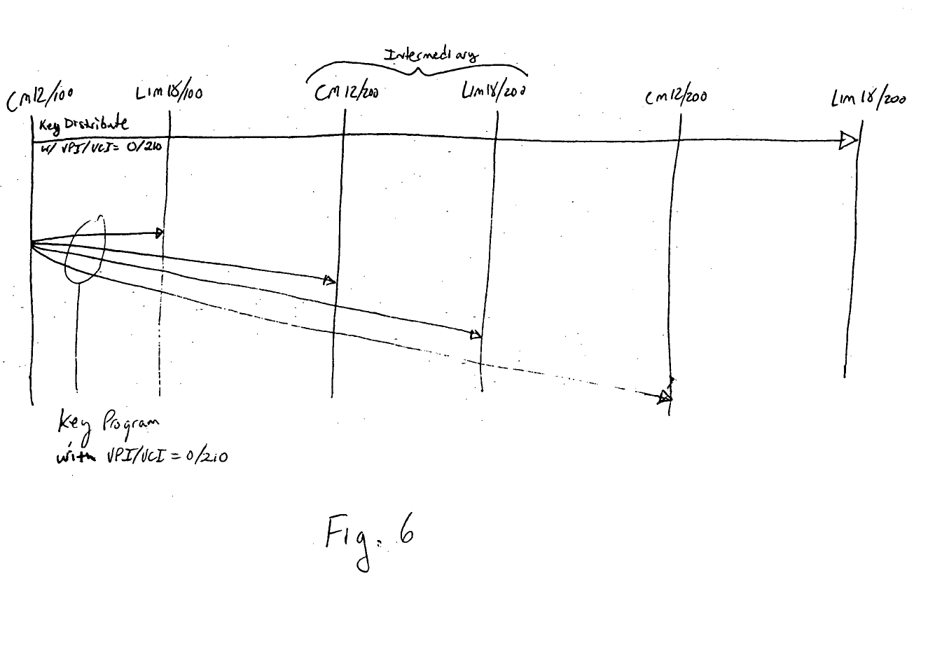

Next, an example embodiment of a messaging scheme for instructing each leg to use the selected internal VPI/VCI or key will be described. FIG. 6 illustrates a communication flow diagram showing the messaging to establish the VPI/VCI within the architecture between the network port 140 and the subscriber port 120 being provisioned. As shown, a key_distribute message is sent from the MC 12 of the master shelf 100 to the LIM 18 having the subscriber port 120 being provisioned. The key_distribute message is sent over the control channel for the LIM 18. The key_distribute message includes a message VPI/VCI, a message type identifier, a subscriber port identifier, the VPI/VCI assigned to the connection between the subscriber port 120 and the subscriber, and the VPI/VCI being assigned. As explained previously, each leg uses the message VPI/VCI and its routing map to properly route the key_distribute message. Here the message VPI/VCI is the control channel for the LIM 18 having the subscriber port 120 being provisioned. The message identifier identifies the message as a key_distribute message. The subscriber port identifier identifies the subscriber port 120 being provisioned. Accordingly, when the LIM 18 receives a key_distribute message, the LIM 18 programs its switch fabric (e.g., updates its routing map) such that when a data packet on the assigned VPI/VCI is received from the associated MC 12 in the secondary shelf 200, the LIM 18 directs the data packet to the subscriber port 120 identified by the subscriber port identifier. Furthermore, the LIM 18 replaces the VPI/VCI of the data packet with the VPI/VCI assigned to the connection between the subscriber port 120 and the subscriber. Similarly, the LIM 18 programs its switch such that when a data packet having the VPI/VCI assigned to the connection between the subscriber port 120 and the subscriber is received over the subscriber port 120 identified by the subscriber port identifier, the LIM 18 replaces this VPI/VCI with the assigned internal VPI/VCI and routes the data packet to its associate MC 12.

The MC 12 of the master shelf 100 also sends a key-program message to the other legs forming the desired path from the MC 12 of the master shelf 100 to the LIM 18 having the subscriber port 120 being provisioned. Namely, in this example, a key_program message is sent to the MC 12 of the secondary shelf 200 having the subscriber port being provisioned, to each leg of each intermediate secondary shelf 200, and to the LIM 18 of the master shelf 100. The key_program message includes a message VPI/VCI, message type identifier, the internal VPI/VCI being assigned, and connection information. The message VPI/VCI is the control channel for the leg to which the key_program message is sent. The message identifier identifies the message as a key_program message. When a leg receives the key_program message, the leg updates its routing map based on the assigned internal VPI/VCI and the connection information. For example, when the leg is an MC 12, the connection information indicates the unique identifier of a network port 14 of the MC 12 and the unique identifier of a LIM 18 associated with the MC 12. Data packets with the assigned internal VPI/VCI will be routed between the identified network port 14 and the identified LIM 18. Similarly, when the leg is a LIM 18, the connection information includes the unique identifier of a subscriber port 20 of the LIM 18. Data packets with the assigned internal VPI/VCI will be routed between the MC 12 associated with the LIM 18 and the identified subscriber port 20.

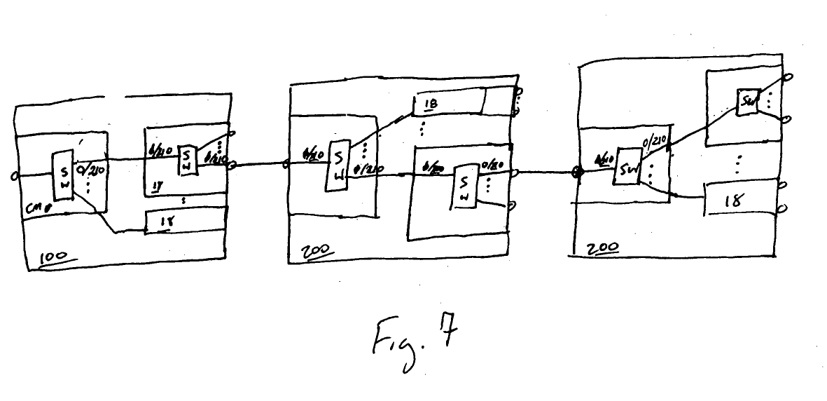

FIG. 7 illustrates the architecture of FIG. 4. However, FIG. 7 provides an example of the VPI/VCI pairs assigned to the subscriber port 120 and the network port 140.

In the above-described embodiment, acknowledgement messages are not sent in response to properly received key_distribute and key_program messages in order to reduce messaging overhead. However, in an alternative embodiment, acknowledgement messages are sent. In the above-described embodiment, when a key_distribute or key_program message is not properly received, a non-acknowledgement message is sent.

While this embodiment of the present invention was described with respect to provisioning a data packet channel, it will be readily appreciated that the same messaging scheme may be employed to set up any number of channels such as OAM channel, additional control channels, testing channels, etc.

Furthermore, it should be appreciated that the architecture described above may handle many different types of communication such as end-to-end and terminated (often referred to as end-to-end call and terminated calls where the term call generically refers to the transmission of information and not necessarily to voice information). As will be further appreciated with respect to terminated communications, the shelves 100,200 include the necessary hardware, memory and programming to properly operate on terminated communications.

The message scheme further includes messages for tearing down a single or multiple communication channels. According to the message scheme, a key_de_program message is used to tear down a single communication channel, and a key_de_program_all message is used to tear down multiple communication channels. The key_de_program message includes a message VPI/VCI, message type identifier, the internal VPI/VCI being torn down. The message VPI/VCI is the control channel for the leg to which the key_de_program message is sent. The message identifier identifies the message as a key_de_program message. When a leg receives the key_de_program message, the leg updates its routing map to remove the internal VPI/VCI and the connection information associated therewith. The key_de_program-all message has the same format at the key_de_program message except that multiple VPI/VCI to tear down are specified.

The invention being thus described, it will be obvious that the same may be varied in many ways. Such variations are not to be regarded as a departure from the spirit and scope of the invention, and all such modifications as would be obvious to one skilled in the art are intended to be included within the scope of the invention.

We claim:

1. A method of establishing a communication channel, comprising:
instructing each leg that forms a desired path within a multiple leg architecture to use a same key for a communication channel.

2. The method of claim 1, wherein the key comprises a VPI/VCI pair.

3. The method of claim 1, wherein the communication channel comprises a data packet channel.

4. The method of claim 1, wherein the communication channel comprises a circuit switched connection.

5. The method of claim 1, wherein the communication channel comprises a control channel.

6. The method of claim 1, wherein the communication channel comprises a operation and management channel.

7. The method of claim 1, wherein the communication channel comprises a testing channel.

8. The method of claim 1, wherein the instructing step comprises:
sending messages from a controller to the legs forming the desired path, each message indicating the key for the communication channel.

9. The method of claim 8, wherein at least one of the messages indicates physical connections for a leg to make for the communication channel.

10. The method of claim 1, wherein the instructing step is performed by a single controller in the architecture.

11. The method claim 1, further comprising:
maintaining a table of available keys for communication channels;
selecting one of the available keys; and wherein
the instructing step instructs the legs forming the desired path within the architecture to use the selected available key for the communication channel.

12. The method of claim 11, wherein the maintaining step maintains a set of available key tables, each table associated with one of a plurality of different types of communication channels.

13. The method of claim 12, wherein the different types of communication channels comprises at least one of a control channel, a data packet channel, an operation and management channel and a testing channel.

14. The method of claim 12, wherein each available key table includes different keys from those in another of the available key tables.

15. The method of claim 12, wherein
the architecture includes a master shelf having a control module and a plurality of slots, each slot for receiving an operation module and the control module for selectively connecting to an operation module in one of the slots; and
the maintaining step maintains a set of the available key tables for each slot.

16. The method of claim 15, wherein each available key table in a set of available key tables comprises different keys from those in another of the available key tables in the set of available key tables.

17. The method of claim 16, wherein at least one available key table comprises a same key as in an available key table in a different set of available key tables.

18. The method of claim 15, wherein at least one available key table comprises a same key as in an available key table in a different set of available key tables.

19. The method of claim 1, wherein the communication channel is for end-to-end communication.

20. The method of claim 1, wherein the communication channel is for terminated communication.
